(19) United States
(12) Patent Application Publication
(10) Pub. No.: US 2026/0138914 A1
(43) Pub. Date: May 21, 2026

(54) GLASS COMPOSITION FOR INSULATION FIBERS AND FIBERIZATION METHOD FOR OBTAINING SUCH FIBERS.

(71) Applicant: SAINT-GOBAIN ISOVER, COURBEVOIE (FR)

(72) Inventor: Guillaume BARBA ROSSA, COURBEVOIE (FR)

(21) Appl. No.: 19/393,934

(22) Filed: Nov. 19, 2025

(30) Foreign Application Priority Data
Nov. 20, 2024 (FR) FR2412690

(51) Int. Cl. C03C 3/091; C03C 1/00; C03C 13/00

(52) U.S. Cl. CPC C03C 3/091; C03C 1/002; C03C 13/00; C03C 2201/10; C03C 2201/32; C03C 2201/50; C03C 2201/54; C03C 2203/10; C03C 2213/00

(57) ABSTRACT

A glass composition for insulation fiber includes, in mass percentage:SiO₂: between 62.0% and 65.0%, Na₂O: between 14.0 and 15.5%, CaO: between 6.0 and 9.0%, MgO: between 1.5 and 4.0%, B₂O₃: between 5.5 and 7.5%, Al₂O₃: between 1.5 and 2.5%, K₂O: between 0 and 2.0%, other oxide(s): between 0 and 5.0% by weight cumulatively, such as between 0 and 2.0% cumulatively, wherein the Na₂O/B₂O₃ ratio is between 1.90 and 2.80.

### CROSS-REFERENCE TO RELATED APPLICATIONS

This application claims priority to French Patent Application No. 2412690, filed Nov. 20, 2024, the entire content of which is incorporated herein by reference in its entirety.

### SUMMARY

Various aspects of the invention relate to a glass composition for insulation fibers and a fiberization method for obtaining insulation fibers.

According to an aspect of the invention, there is provided a glass composition for insulation fiber comprising, in mass percentage:
SiO₂: between 62.0% and 65.0%,
Na₂O: between 14.0 and 15.5%,
CaO: between 6.0 and 9.0%,
MgO: between 1.5 and 4.0%,
B₂O₃: between 5.5 and 7.5%,
Al₂O₃: between 1.5 and 2.5%,
K₂O: between 0 and 2.0%,
other oxide(s): between 0 and 5.0% by weight cumulatively, such as between 0 and 2.0% cumulatively,
wherein the Na₂O/B₂O₃ ratio is between 1.90 and 2.80.

According to another aspect of the invention, there is provided a method for manufacturing glass fibers, having the composition as disclosed herein, the method comprising the melting of a mixture of raw materials constituting a melt and the fiberization of said molten mixture,
the melt comprising:
   glass cullet comprising a silica weight percentage greater than 70%, such as greater than 71%,
   at least one aluminum source,
   at least one source of boron,
   optionally at least one source of magnesium,
   optionally at least one source of sodium selected from sodium hydroxide NaOH, sodium silicate, sodium nitrate or a mixture thereof;
   optionally at least one source of calcium,
optionally sources of at least one element selected from phosphorus P, manganese Mn, iron Fe, fluorine F,
wherein said glass cullet represents, by mass, more than 70%, such as more than 75%, of the molten glass obtained from the mixture of raw materials constituting the melt.

### DETAILED DESCRIPTION

An aspect of the invention relates to the production of insulating mineral wool, in particular glass wool. An aspect of the invention relates more particularly to an optimization of the formulation of the final glass composition and of the raw material mixture (or recipe) used for such production, with the aim of preserving the essential properties by enabling the extensive use of recycled materials, in particular of cullet of float glass, of borosilicate glass or else of packaging glass (bottle).

An aspect of the invention relates to the field of melting a mixture of raw materials, in particular for the manufacture of a glass wool as used notably in the field of thermal and/or acoustic insulation of buildings or the like.

At present, sodium carbonate (often referred to as soda ash in the literature) is extensively used as a sodium carrier (=raw material providing the sodium element in the final glass matrix) for the production of fiberglass for insulation. There is currently a desire among glass wool producers to reduce the amount of sodium carbonate needed for glass production, or even to eliminate the use thereof, particularly in the field of insulation glass production, for a variety of reasons:
Soda ash is highly hygroscopic: any batch containing even a small fraction of soda ash has a tendency to congeal in temporary storage silos, which leads to process problems and risky cleaning procedures.
Soda ash contributes significantly to greenhouse gas (CO₂) emissions.

In particular, according to a first major shortcoming, during the melting of a glass composition thus formed, the carbonates produce CO₂ by reacting in the glass with the appearance of a bubbling phenomenon. Additionally, the extraction, the production and/or the transportation of soda ash generate significant CO₂ emissions. Finally, the soda ash market can be tight and the prices of sodium carbonate can be relatively high and volatile.

According to a first aspect, the present invention makes it possible to minimize the use of sodium carbonate, or even to eliminate it in a glass recipe comprising a mixture of raw materials for the manufacture of glass wool, while retaining the main properties of glass necessary for the insulation of said glass wool.

A beneficial way of minimizing the carbonate content, in particular sodium carbonate, of such a recipe consists, according to the recipe, of increasing the proportion of recycled materials (float glass cullet, bottle cullet, borosilicate glass, waste from the production of mineral wool and in particular glass wool). However, the glass matrices of float cullet (i.e. derived from recycled flat glass used in the construction industry) and of bottle cullet or else of borosilicate glass differ considerably from the chemistry of insulating glass. The latter, for example, has a lower silica content, and therefore there is an upper limit to the proportion of this cullet that can be used in the recipe.

Common cullet compositions for flat glass and bottled glass are shown in Table 1 below:

TABLE 1

| Elements | Float glass cullet | Bottle glass cullet |
|---|---|---|
| SiO₂ | 72.0 | 71.4 |
| CaO | 8.8 | 10.4 |
| B₂O₃ | — | — |
| Na₂O | 13.7 | 12.5 |
| MgO | 3.6 | 1.5 |
| Al₂O₃ | 0.7 | 1.9 |
| Fe₂O₃ | 0.5 | 0.5 |
| K₂O | 0.2 | 0.6 |
| Other oxides | remainder | remainder |

If we consider that the silica content of the float glass and of the packaging glass averages around 72% by weight, and that the silica content of insulating glass wool is around 64% by weight, we can approximate a theoretical upper limit of 64/72=89% for the use of flat glass cullet in the manufacturing recipe of a typical glass wool. For other reasons, such as the presence of silica in the raw materials required for insulating glass production (feldspar, oxidizing agents), an upper limit may be set at 85% by weight.

With such a large amount of cullet, the insulating glass recipe is also beneficially free of sand (which is a resource under pressure), and even of calcium and magnesium carriers likely to be carbonated.

A further aspect of the present invention is thus to provide a glass composition for mineral insulation fibers adapted to allow the use of a maximum amount of flat or packaging (bottle) glass cullet.

The composition of the glass used as insulation in today's glass wool generally has a higher alumina, boron and sodium content than the float glass and the packaging glass. As a result, in addition to recycled materials, the remaining fraction of the batch (raw materials, natural or synthetic) can provide other key elements for the production of glass wool in particular:
aluminum (for example introduced as raw material in the form of feldspar, nepheline, phonolite, etc.)
boron (for example introduced as raw material in the form of borax hydrates, boric acid, kernite, etc.)
optionally sodium in non-carbonated form (sodium hydroxide NaOH, sodium silicates, sodium nitrate, sodium sulfate, etc.).

While alumina and boron carriers are generally carbonate-free, this is not the case for sodium carriers. Some studies suggest exchanging sodium carbonate with sodium-loaded carbonate-free materials such as the sodium nitrate or the sodium sulfate mentioned hereinbefore. These materials have a number of disadvantages, such as the risks associated with their properties (hygroscopicity, corrosion, explosiveness), and the emission of gases and pollutants (NOx, SOx). Additionally such use may require a radical change in processing equipment, mixing, conveying and/or melting technologies. These alternative materials should therefore be minimized in the recipe.

The following describes the fundamental properties used for molten glass compositions useful for fiberglass fiberization:
the temperature corresponding to a viscosity of 1000 poises, noted “T_{log3}” and expressed in degrees Celsius, corresponding to the typical fiberization temperature,
the liquidus temperature, noted “T_{liq}” or Tliquidus, corresponding to the temperature below which the first crystals can form.

It is relevant, for the correct implementation of the fiberization method, to limit the liquidus temperature T_{liq} of the glass produced, so as not to have to increase the temperatures of the molten glass in the fiberizing dishes, in order to avoid the presence of crystals that disrupt the glass-forming process. An increase in T_{liq} translates in particular into additional energy costs, and reduces the service life of the dishes used for fiberization and/or the quality of the end product. Also, if the temperature of the glass falls below T_{liq} as it passes through the fiberization tools, particularly in the drilled dish, there is a risk of clogging the calibrated holes of this part due to crystallization.

Additionally, the forming margin, i.e. manufacturing by drawing the fibers, can be carried out in a temperature range corresponding to the difference between T_{log3} and T_{liq}, noted “ΔT” and expressed in degrees Celsius. The greater this difference, the more the fiberization method can be carried out under conditions that avoid the aforementioned disadvantages.

The use of cullet in large amounts for the manufacture of glass fibers for insulation, in particular for more than 60%, or even more than 70%, or even more than 75% or even more than 80% of the mass of molten glass (excluding internal recycled cullet) enabling said manufacture, is an aspect of the present invention.

An aspect of the present invention is, in particular, to provide a glass composition and an associated method that enable a very large amount of cullet to be used without risking problems of clogging of the fiberization instruments through premature crystallization of the molten glass in the latter if the T_{liq} is too high and/or if the forming margin is too narrow.

This use was made possible according to one or more aspects of the invention by adapting the composition of the target glass so as to introduce large amounts of cullet into the melt.

According to an aspect of the invention, it has been found that it was possible to maintain the liquidus temperature of a raw material mixture very rich in silica-rich cullet at temperatures less than or equal to 920° C. and a forming margin greater than 120° C. by specifically adapting the molten glass composition and by selecting in the vitrifiable mixture the raw materials from the list described below.

Thus, an aspect of the invention proposes an optimization of the final oxide content of the glass, while maintaining the properties of the glass, as well as a method of selecting raw materials that minimizes or avoids the use of sodium carbonate or, more generally, soda-carbonate carriers in the recipe.

The mass fraction of Na₂O contributed by a sodium carrier in the glass matrix can be calculated according to the following formula:

$$f = \frac{{m}_{carrier}}{{m}_{glass}} \times {f}_{{Na}_{2} O}$$

with m_{carrier} the mass of carrier in the recipe to produce a mass m_{glass} of glass and f_{Na2O} the mass fraction of Na₂O in the carrier considered. The mass fraction of Na₂O contributed by all sodium carriers is the sum of all mass fractions of Na₂O contributed by each sodium carrier.

An aspect of the present invention is in particular to provide a glass composition which can be used as an insulation fiber and which can be manufactured using as raw material more than 70% by weight of glass cullet comprising more than 70% by weight of SiO₂ and desirably without the need for carbonate(s), in particular without sodium carbonate.

More precisely, according to a first aspect, the present invention relates to a glass composition for insulation fiber and said glass fiber having the following composition, in mass percentage:
SiO₂: between 62.0% and 65.0%,
Na₂O: between 14.0 and 16.0%, such as between 14.0 and 15.5%
CaO: between 6.0 and 9.0%,
MgO: between 1.5 and 4.0%,
B₂O₃: between 5.5 and 7.5%,
Al₂O₃: between 1.5 and 2.5%,
K₂O: between 0 and 2.0%,
other oxide(s): between 0 and 5.0% by weight cumulatively, for example between 0 and 2.0% cumulatively, and
wherein the Na₂O/B₂O₃ ratio is between 1.90 and 2.80.

According to other beneficial embodiments of the composition according to the present invention, which can, if appropriate, be combined with one another:
The Na₂O/B₂O₃ ratio is between 2.10 and 2.50, for example between 2.10 and 2.40, such as between 2.10 and 2.30.
The mass percentage of Na₂O is between 14.5 and 15.5%.
The mass percentage of B₂O₃ is between 6.5 and 8.0%, such as between 6.7 and 7.5%.
The mass percentage of Al₂O₃ is between 1.6 and 2.0%.
The mass percentage of SiO₂ is between 63.0 and 64.0%.
The mass percentage of MgO is between 2.5 and 3.5%.
The CaO mass percentage is between 8.0 and 9.0%.
The glass composition has a T_{log3} value of between 103° and 1080° C., T_{log3} being the temperature corresponding to a viscosity of 103 poises of the molten composition.
The glass composition has a T_{liq} value below 925° C., for example less than 920° C., T_{liq} being the temperature below which the first crystals form when the molten composition cools.
The glass composition has a difference ΔT between its T_{log3} and T_{liq} values greater than 100° C., such as greater than 110° C.

An aspect of the invention also relates to glass fibers corresponding to the previous composition and obtained by melting and fiberizing it, as well as to the glass fiber mat comprising an assembly of such glass fibers, bonded by an organic or inorganic binder.

An aspect of the present invention also relates to a method for manufacturing said glass fibers of said composition, said method comprising melting a mixture of raw materials constituting a melt and fiberizing said molten mixture, method wherein said melt comprises:
glass cullet comprising a silica weight percentage greater than 70%, such as greater than 71%,
at least one aluminum source
at least one source of boron,
optionally at least one source of magnesium
optionally at least one sodium source such as selected from sodium hydroxide NaOH or sodium silicate, sodium nitrate or a mixture thereof;
optionally at least one source of calcium,
optionally sources of at least one element selected from phosphorus P, manganese Mn, iron Fe, fluorine F, said method wherein said glass cullet represents, by mass, more than 70%, such as more than 75%, of the molten glass obtained from the mixture of raw materials constituting the melt.

According to beneficial embodiments of the method according to the invention:
the amounts of the source(s) of sodium and of boron are introduced into the raw material mixture in amounts such that the Na₂O/B₂O₃ ratio is between 1.90 and 2.80 in said target composition, such as between 2.10 and 2.50, for example between 2.10 and 2.40 or even between 2.10 and 2.30.
One or the boron source is selected from a boron oxide such as boric acid or a mixed oxide of boron with at least one element selected from the group consisting of Si, Mg, Ca, Na, in particular an oxide selected from the group consisting of anhydrous borax or borax pentahydrate, natural or synthetic colemanite, optionally calcined ulexite, hydroboracite, razorite, tincal(conite) or kernite, and mixtures thereof.
One or the source of boron is borax pentahydrate.
One or the source of aluminum is selected from a mixed oxide of aluminum with at least one element selected from the group consisting of Si, Ca, Na, K, in particular a silicate of aluminum and at least one element selected from Ca, Na or K, or hydrated (Al(OH)₃) or calcined alumina Al₂O₃, a feldspar of general composition (K, Na)AlSi₃O₈ or a phonolite for example of general composition 4SiO₂·Al₂O₃·0.5(Na₂O·K₂O) or a nepheline for example of general composition 4SiO₂·Al₂O₃·0.5(Na₂O·K₂O).
The mixture of raw material further comprises a source of calcium that is, in an embodiment, selected from the group consisting of lime, for example quicklime or slaked lime, or limestone.
In addition to said cullet, the mixture of raw materials comprises only oxides, optionally in the form of hydrates.
At least a portion of said glass cullet is derived from float glass.
At least a portion of said glass cullet is derived from borosilicate glass.
At least a portion of said glass cullet is derived from bottle glass.

The following examples exemplify the benefits of the present invention.

In these examples, two glass compositions for insulation fibers are compared.

The glass composition according to Example 1 is comparative and that of Example 2 conforms to an embodiment of the present invention.

The target formulations are given in Table 2 below:

TABLE 2

| mass % | SiO₂ | Al₂O₃ | Na₂O | K₂O | CaO | MgO | B₂O₃ | Fe₂O₃ | MnO | P₂O₅ | SO₃ |
|---|---|---|---|---|---|---|---|---|---|---|---|
| Example 1* | 64.1 | 1.83 | 16.1 | 0.47 | 7.9 | 2.8 | 5.2 | 0.51 | 0.75 | 0.13 | 0.19 |
| Example 2** | 63.6 | 1.84 | 15.0 | 0.45 | 7.6 | 3.0 | 6.9 | 0.51 | 0.75 | 0.13 | 0.21 |

*comparative
**according to the invention

Both glasses are obtained from the initial raw materials given in Table 3 below:

TABLE 3

| | Example | Example |
|---|---|---|
| Kilograms | composition 1 | composition 2 |
| Float glass cullet | 719 | 827 |
| Bottle glass cullet | 124 | 0 |
| Feldspar | 51 | 60 |
| Borax pentahydrate | 106 | 142 |
| Sodium carbonate | 33 | 0 |
| Calcium phosphate | 4 | 4 |
| Sodium nitrate | 3 | 3 |
| Manganese dioxide | 10 | 10 |
| Proportion of recycled cullet in | 84.3 | 82.7 |
| the final glass (mass %) | | |
| Proportion of Na₂O contributed | 1.9 | 0 |
| by the carbonated raw materials | | |
| (mass %) | | |

Table 4 below shows the oxide composition of the raw materials used:

TABLE 4

| weight % | SiO₂ | Al₂O₃ | Na₂O | K₂O | CaO | MgO | B₂O₃ | Fe₂O₃ | MnO | P₂O₅ | SO₃ |
|---|---|---|---|---|---|---|---|---|---|---|---|
| Float glass | 72 | 0.73 | 13.72 | 0.22 | 8.83 | 3.62 | 0 | 0.52 | 0 | 0 | 0.24 |
| cullet | | | | | | | | | | | |
| Bottle glass | 71.4 | 1.90 | 12.48 | 0.62 | 10.40 | 1.49 | 0 | 0.45 | 0 | 0 | 0.1 |
| cullet | | | | | | | | | | | |
| Feldspar | 67 | 19.53 | 7.16 | 4.52 | 0.85 | 0.33 | 0 | 0.11 | 0 | 0 | 0 |
| Borax | 0 | 0 | 21.5 | 0 | 0 | 0 | 48.7 | 0 | 0 | 0 | 0 |
| pentahydrate | | | | | | | | | | | |
| Sodium | 0 | 0 | 58.48 | 0 | 0 | 0 | 0 | 0 | 0 | 0 | 0 |
| carbonate | | | | | | | | | | | |
| Calcium | 1 | 0.1 | 0.7 | 0.05 | 52.5 | 0.35 | 0 | 0.1 | | 31.5 | 1.8 |
| phosphate | | | | | | | | | | | |
| Sodium nitrate | 0 | 0 | 39.23 | 0 | 0 | 0 | 0 | 0 | 0 | 0 | 0 |
| Manganese | 4.56 | 7.02 | 0 | 0 | 0.06 | 0.07 | 0 | 6.7 | 74.7 | 0 | 0 |
| dioxide | | | | | | | | | | | |

It can be shown that the glass target according to Example 1, for such proportions of use of float or bottle glass in the initial raw material recipe, cannot be obtained without the addition of a substantial amount of sodium carbonate, flat or bottle glass cullets containing significantly less sodium in mass fraction than the typical target for an insulating glass. On the contrary, the adjusted glass target according to an aspect of the invention can be obtained without the use of a specific sodium carrier.

The properties of two glasses are given in Table 5 below:

TABLE 5

| ° C. | T_{liq} | T_{Log3} | ΔT = T_{Log3} − T_{liq} |
|---|---|---|---|
| Example 1 | 914 | 1044 | 130 |
| Example 2 | 919 | 1040 | 121 |

It can be seen that the glass composition according to an aspect of the invention meets all the above-mentioned principles. The adjusted glass beneficially has:
T_{log3} and T_{liq} values close to the values of the comparative glass (with a difference of less than or equal to 5° C.), which ensures all the necessary safety in the fiberization method, as the difference between the two values remains greater than 120° C.
the amount of alumina is maintained at a value close to 2% by mass, which guarantees the biosolubility of the fibers produced.

Additionally, the higher boron content increases the ability of the final product to scatter IR light and as a result its thermal insulation properties.

Finally, the composition for insulating glass fibers and the method for obtaining it make it possible:
to use, in the initial raw material recipe, very large amounts of glass cullet of different composition, in particular float glass cullet, borosilicate glass cullet or else bottle glass cullet,
to minimize the amount of the source of sodium, in particular in the form of carbonate, in the initial recipe and required for such a proportion of glass cullet,
to maintain the proper viscosity of the glass at the fiberization temperature,
to maintain a sufficiently low liquidus temperature to allow such fiberization without increased difficulty,
to maintain the biosolubility properties of the glass wool produced according to the current standards,
or even to improve the diffusion of the light through the glass fibers (for example by increasing the boron content).

According to further benefits associated with particular embodiments of the invention, carbonate-free boron and alumina carriers are selected to introduce a maximum amount of sodium, such as borax pentahydrate (instead of boric acid) and/or sodium feldspar (instead of potassium feldspar and/or mixed feldspar).

The compositions and methods disclosed herein provide significant technical and operational benefits relative to carbonate-dependent recipes used for manufacturing insulation fibers. As evidenced by the comparative formulations and raw-material oxide contributions summarized in Table 4, the composition according to an aspect of the invention achieves the target oxide windows while minimizing or eliminating sodium carbonate in the batch. Notwithstanding these raw-material changes, the resulting glasses maintain fiberization behavior substantially equivalent to the comparative glass, including similar liquidus temperatures (Tliq) and fiberization viscosities (Tlog 3) and a robust forming margin (ΔT), as reflected in the properties data. These benefits flow directly from the controlled oxide windows (e.g., SiO₂, Na₂O, B₂O₃, Al₂O₃, MgO, CaO) and the specified Na₂O/B₂O₃ ratio maintained by aspects of the invention.

In particular, the comparison between the example according to the invention and the comparative example shows that, despite the removal of sodium carbonate from the inventive recipe and the corresponding redistribution of sodium and boron sources identified in Table 4, the inventive glass maintains Tliq and Tlog 3 within a few degrees of the comparative glass and preserves a forming margin in excess of 120° C. Accordingly, the inventive compositions permit fiberization without increased difficulty, avoiding clogging or crystallization in the fiberizing dish and preserving process stability across typical manufacturing tolerances. These results are not limited to the exact stoichiometries of the individual examples; rather, they are characteristic of compositions throughout the disclosed oxide ranges and Na₂O/B₂O₃ ratios.

Because various aspects of the invention control both absolute oxide contents and the Na₂O/B₂O₃ ratio, the glass network structure and liquidus behavior remain stable across the ranges (e.g., SiO₂ 62-65 wt. %, Na₂O 14.0-15.5 wt. %, B₂O₃ 5.5-7.5 wt. %, Al₂O₃ 1.5-2.5 wt. %, MgO 1.5-4.0 wt. %, CaO 6.0-9.0 wt. %). Maintaining these ranges yields Tliq values at or below 925° C. (desirably s 920° C.) and ΔT values greater than 100° C. (desirably >110° C.), thereby ensuring that the fiberization window remains industrially robust even when batch sodium is supplied predominantly by carbonate-free carriers and high-SiO₂ cullet.

The inventive compositions further enable extensive use of recycled glass cullet (e.g., float, borosilicate, bottle), which reduces or eliminates the need for sand and other carbonate-bearing raw materials. This affords multiple benefits: (i) reduced CO₂ emissions associated with carbonate decomposition and diminished upstream impacts tied to carbonate extraction and transport; (ii) avoidance of hygroscopic handling problems and silo agglomeration commonly associated with soda ash; and (iii) simplified batching using predominantly oxides and/or hydrates. Importantly, these sustainability and operational benefits are achieved without sacrificing forming performance, as demonstrated by the close alignment of Tliq, Tlog 3, and ΔT between the inventive and comparative glasses notwithstanding the Table-4 raw-material differences.

The alumina level is maintained near 2 wt. % (+/−10%) across the disclosed ranges, supporting biosolubility of the resulting fibers in accordance with prevailing standards. At the same time, the slightly elevated boron content in the inventive compositions enhances infrared scattering within the fiber mat, which can improve thermal insulation performance without compromising processing. These benefits—biosolubility preservation and IR-scattering enhancement—likewise persist throughout the stated oxide windows and Na₂O/B₂O₃ ratios because the governing network-modifier/network-former balance is preserved by the claimed ranges.

From a manufacturing standpoint, the inventive window also protects tooling life by avoiding unnecessary temperature elevation in the fiberizing equipment (which would otherwise be required if Tliq were increased) and by maintaining viscosity at the fiberization temperature (Tlog 3) within a narrow band suited to stable filament drawing. The ability to achieve these outcomes with large cullet fractions and without reliance on sodium carbonate (and while minimizing alternative reactive sodium carriers) provides a practical route to decarbonized batching and smoother plant operations-again, not only at the specific example compositions, but throughout the disclosed ranges and preferred sub-ranges.

Accordingly, the results around Table 4 (and the corresponding properties data) demonstrate that the inventive formulation strategy—high-cullet batching with controlled Na₂O/B₂O₃ and oxide contents—delivers equivalent forming performance and improved environmental and handling characteristics relative to carbonate-dependent comparative recipes. The skilled person will appreciate that, given the demonstrated insensitivity of Tliq, Tlog 3, and ΔT to the specific redistribution of sodium and boron sources within the stated limits, the same benefits will be realized across the entirety of the claimed ranges, including the preferred and more-preferred sub-ranges.

It will be appreciated that the benefits demonstrated by the inventive examples relative to the comparative example—namely, maintaining suitable liquidus and fiberization viscosities and a robust forming margin under carbonate-free batching—are obtained when the Na₂O/B₂O₃ ratio (as defined herein) is held within the claimed range. Without being bound by theory, ratios below the recited lower limit over-constrain the network with boron relative to sodium, which increases viscosity at fiberizing temperatures and/or narrows the forming margin, while ratios above the recited upper limit over-depolymerize the network, which elevates liquidus and/or depresses viscosity into an unstable regime and can promote unwanted phase separation or devitrification. In either case, compositions outside the claimed ratio range fail to reproduce the combination of properties evidenced by Table 4 for the inventive examples (stable Tliq, acceptable Tlog 3, and industrially adequate ΔT), and thus do not deliver the process or performance advantages described herein.

In certain embodiments, the mixture of raw materials, in addition to the cullet, consists of oxides, optionally in the form of hydrates, such that the batch is free of carbonate, nitrate and sulfate salt carriers.

In some embodiments, the recipe is free of sodium carbonate and, more generally, free of soda-carbonate carriers; sodium is provided by the cullet and/or by carbonate-free sources when used.

In some embodiments, no specific sodium carrier is present, and the Na₂O of the target composition is furnished by the cullet and the other oxides/hydrates of the batch.

In some embodiments, the recipe is free of sand and even free of carbonate-containing calcium or magnesium carriers (e.g., limestone and dolomite).

In further embodiments, the batch is free of nitrate- or sulfate-based sodium carriers, which are minimized or avoided due to handling and emissions concerns.

In some embodiments, the boron source is free of boric acid and comprises borax pentahydrate as the boron carrier.

In some embodiments, the composition is free of intentional potassium additions (e.g., K₂O=0% by mass, subject only to incidental impurities), consistent with the disclosed 0-2.0 wt. % K₂O window.

In some embodiments, the composition is free of intentional “other oxide(s)”, with such oxides present, if at all, only as incidental impurities within the disclosed cumulative 0-5 wt. % (for example 0-2 wt. %) total.

In some embodiments of the high-cullet process, the proportion of Na₂O contributed by carbonated raw materials is 0% by mass, evidencing the absence of carbonate carriers in the batch.

As used herein, “free of” indicates the absence of any intentional addition of the recited material to the batch and allows for only incidental or adventitious impurities introduced by recycled cullet or other raw materials.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The articles “a” and “an” may be employed in connection with various elements and components, processes or structures described herein. This is merely for convenience and to give a general sense of the processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

A person skilled in the art will readily appreciate that various features, elements, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

1. A glass composition for insulation fiber comprising, in mass percentage:
SiO₂: between 62.0% and 65.0%,
Na₂O: between 14.0 and 15.5%,
CaO: between 6.0 and 9.0%,
MgO: between 1.5 and 4.0%,
B₂O₃: between 5.5 and 7.5%,
Al₂O₃: between 1.5 and 2.5%,
K₂O: between 0 and 2.0%,
other oxide(s): between 0 and 5.0% by weight cumulatively,
wherein the Na₂O/B₂O₃ ratio is between 1.90 and 2.80.

2. The glass composition according to claim 1, wherein the Na₂O/B₂O₃ ratio is between 2.10 and 2.50.

3. The glass composition according to claim 1, wherein the mass percentage of Na₂O is between 14.5 and 15.5%.

4. The glass composition according to claim 1, wherein the mass percentage of B₂O₃ is between 6.5 and 8.0%.

5. The glass composition according to claim 1, wherein the mass percentage of Al₂O₃ is between 1.6 and 2.0%.

6. The glass composition according to claim 1, wherein the mass percentage of SiO₂ is between 63.0 and 64.0%.

7. The glass composition according to claim 1, wherein the mass percentage of MgO is between 2.5 and 3.5%.

8. The glass composition according to claim 1, wherein the mass percentage of CaO is between 8.0 and 9.0%.

9. The glass composition according to claim 1, having a T_{log3} value between 103° and 1080° C., T_{log3} being the temperature corresponding to a viscosity of 103 poises of the molten composition.

10. The glass composition according to claim 1, having a T_{liq} value less than 925° C., T_{liq} being a temperature below which first crystals form when the molten composition cools.

11. The glass composition according to claim 1, having a difference ΔT between its T_{log3} and T_{liq} values greater than 100° C.

12. The glass fibers for insulation corresponding to the composition according to claim 1.

13. A glass fiber mat comprising an assembly of glass fibers according to claim 12, bonded by an organic or inorganic binder.

14. A method for manufacturing glass fibers, having the composition according to claim 1, the method comprising melting a mixture of raw materials constituting a melt and the fiberization of said molten mixture,
said melt comprising:
glass cullet comprising a silica weight percentage greater than 70%,
at least one aluminum source,
at least one source of boron,
optionally at least one source of magnesium,
optionally at least one source of sodium selected from sodium hydroxide NaOH, sodium silicate, sodium nitrate or a mixture thereof,
optionally at least one source of calcium,
optionally sources of at least one element selected from phosphorus P, manganese Mn, iron Fe, fluorine F,
wherein said glass cullet represents, by mass, more than 70% of the molten glass obtained from the mixture of raw materials constituting the melt.

15. The method for manufacturing glass fibers according to claim 14, wherein the amounts of the source(s) of sodium and of boron are introduced into the raw material mixture in amounts such that the Na₂O/B₂O₃ ratio is between 1.90 and 2.80 in said target composition.

16. The method for manufacturing glass fibers according to claim 14, wherein a source of boron is selected from a boron oxide or a mixed oxide of boron with at least one element selected from the group consisting of Si, Mg, Ca, Na and mixtures thereof.

17. The method for manufacturing glass fibers according to claim 14, wherein a source of boron is borax pentahydrate.

18. The method for manufacturing glass fibers according to claim 14, wherein the aluminum source is selected from a mixed oxide of aluminum with at least one element selected from the group consisting of Si, Ca, Na, K.

19. The method for manufacturing glass fibers according to claim 14, wherein the raw material mixture further comprises a calcium source selected from the group consisting of lime and limestone.

20. The method for manufacturing glass fibers according to claim 14, wherein the mixture of raw materials comprises, in addition to said cullet, only oxides, optionally in the form of hydrates.

21. The method for manufacturing glass fibers according to claim 14, wherein at least a portion of said glass cullet is derived from float glass.

22. The method for manufacturing glass fibers according to claim 14, wherein at least a portion of said glass cullet is derived from borosilicate glass.

23. The method for manufacturing glass fibers according to claim 14, wherein at least a portion of said glass cullet is derived from bottle glass.
